(19) United States
(12) Patent Application Publication
(10) Pub. No.: US 2022/0277262 A1
(43) Pub. Date: Sep. 1, 2022

(54) TRACKING OF OBJECTS

(71) Applicant: BAYER AKTIENGESELLSCHAFT, Leverkusen (DE)

(72) Inventors: Hermann HERTER, Leverkusen (DE); Andrej CEH, Köln (DE)

(21) Appl. No.: 17/638,786

(22) PCT Filed: Aug. 24, 2020
(86) PCT No.: PCT/EP2020/073588

§ 371 Date: Feb. 25, 2022

(30) Foreign Application Priority Data
Aug. 29, 2019 (EP) 19194253.1

(51) Int. Cl. G06Q 10/08; G06F 16/22

(52) U.S. Cl. CPC G06Q 10/0833; G06F 16/2282

(57) ABSTRACT

The present invention relates to the tracking of objects. The present invention relates to a method, a system and a computer program product for tracking objects.

### TRACKING OF OBJECTS

The present invention relates to the tracking of objects. The present invention provides a method, a device and a computer program product for tracking objects.

The tracking of objects plays a major role in many areas of the economy. One example is the tracking of goods, along their value creation chain. This is usually done by providing goods with a unique identifier (e.g. a serial number), a process known as serialization, so that they can be uniquely identified at a later date. The unique identifier is usually printed as an optoelectronically readable code (barcode, 2D code) on the packaging of a commodity or is stored in an RFID transponder connected to the goods. At different points in the value chain, e.g. during packing, loading, on arrival, e.g. in a warehouse and/or on acceptance by a customer and/or the like, the unique identifiers are recorded and the respective status changes of the goods are stored in a database.

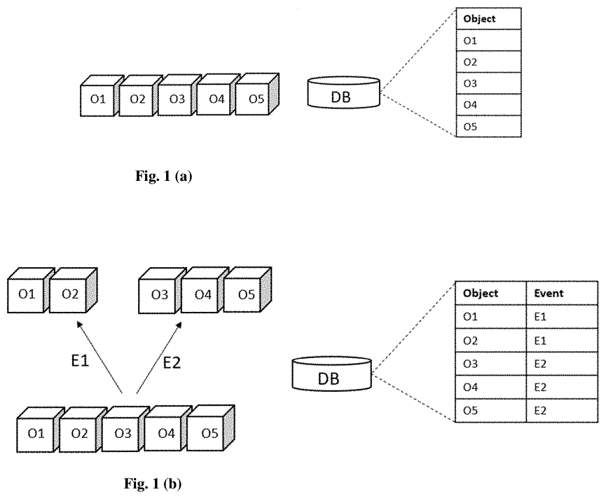

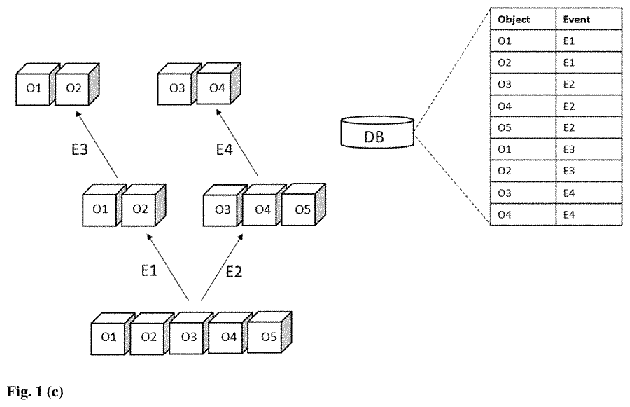

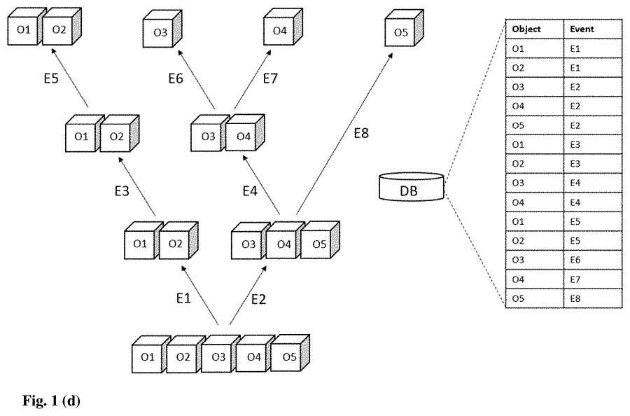

Usually, the status changes are recorded in a relational database in the form of a table. The table usually includes the unique identifiers of the goods as well as information about which (defined) events occurred for the respective goods. This is depicted exemplarily in FIG. 1. FIG. 1(a) shows five objects O1, O2, O3, O4 and O5. Each object is identifiable by a unique identifier; in this case, by the object identifiers O1, O2, O3, O4 and O5. Information about the objects is stored in tabular form in a data store DB. Each object in the data store is represented by its object identifier. In FIG. 1(b), two events E1 and E2 are depicted schematically. For the objects O1 and 02, the event E1 has occurred; for the objects O3, O4 and O5, the event E2 has occurred. The data store DB stores which event has occurred for the objects in each case. The event is represented in the table by an event identifier (E1, E2). FIG. 1(c) shows that two further events E3 and E4 have occurred. For the objects O1 and O2, the event E3 has occurred; for the objects O3 and O4 the event E4 has occurred. The data store DB again stores which event has occurred for the objects in each case. For each new event that occurred, a new entry is created for each object for which the event occurred. FIG. 1(d) shows that four other events E5, E6, E7 and E8 have occurred. For objects O1 and O2, event E5 occurred; for object O3, event E6 occurred; for object O4, event E7 occurred; for object O5, event E8 occurred. The data store DB again stores which event has occurred for the objects in each case.

In tracking the objects as shown in FIG. 1(a) to (d), the table grows with each newly occurring event by a number of new entries corresponding to the number of objects for which the new event occurs. It is assumed that a total of N objects are tracked, where N is an integer and greater than 1. The events E₁ to Eₙ occur, where n is an integer and greater than 1. It is assumed that the event E1 affects a number N₁ of objects, the event E₂ affects a number N₂ of objects, and so on. The number Z of entries in the database is then given by Z=N₁ +N₂+ . . . +Nₙ.

Usually, the number N of objects being tracked is much greater than the number n of events occurring. In particular when tracking goods, the number N of the tracked objects can assume very large values. This means that a large amount of data must be generated and stored. The data is usually used by various parties involved in the value creation chain of the goods and must therefore be transferred from one party to another. This creates a large amount of data traffic.

Based on the prior art, the object was to reduce the amount of data required for tracking objects

This object is achieved by the subjects of the independent claims. Preferred embodiments can be found in the dependent claims, in the present description and the figures.

The present invention therefore provides, in a first aspect, a method for tracking of objects, comprising the steps of:
providing a plurality of objects
recording events that have occurred for the objects, and
storing information about the objects and the events that occurred in a first table and in a second table

wherein in the first table, each object is represented by a unique object identifier,

wherein in the first table, for each object the most recent event that occurred for that particular object is stored,

wherein in the second table, for each event which is immediately preceded by an event, the respective previous event is entered.

A further object of the present invention is a device comprising

an input unit

a control and calculation unit, and

a data memory

wherein the control and calculation unit is configured to prompt the input unit to receive object identifiers of a plurality of objects,

wherein the control and calculation unit is configured to create a first table, wherein each object in the first table is represented by the respective object identifier,

wherein the control and calculation unit is configured to prompt the input device to receive information about events and about the objects for which the respective events occurred,

wherein the control and calculation unit is configured to record in the first table which event occurred last for the objects,

wherein the control and calculation unit is configured to create a second table and, for each event preceded by an event, to record the immediately preceding event in the second table,

wherein the control and calculation unit is configured to store the first table and the second table in the data store.

Another subject of the present invention is a computer program product comprising program code that is stored on a data carrier and that prompts a computer system to perform the following steps when the program code is loaded into the working memory of the computer system:
receiving object identifiers of a plurality of objects,
generating a first table, wherein each object in the first table is represented by the respective object identifier,
receiving information about events and about the objects for which the respective events occurred,
for all objects for which at least one event has occurred: entering the last event in the first table,
creating a second table,
for each event that has occurred for at least one object and is preceded by at least one event: entering the immediately preceding event in the second table,
storing the first table and the second table in a data store.

The invention is explained in more detail below without distinguishing between the aspects of the invention (method, device, computer program product). The explanations that follow shall instead apply analogously to all aspects of the invention, regardless of the context (method, device, computer program product) in which they are given.

If steps are stated in an order in the present description or in the claims, this does not necessarily mean that the invention is restricted to the stated order. On the contrary, it is possible for the steps also to be able to be executed in a different sequence or else in parallel to one another, unless one step builds upon another step, which by definition means that the step building upon the other is executed subsequently (but this will be clear in the individual case). The stated orders are thus preferred embodiments.

The present invention is used for the tracking of objects. An “object” is preferably a physical (tangible, material) object. The objects described here are preferably goods. The term “goods” refers to moveable things that are, or may be, the subject of commercial activity. The most preferred objects (goods) are pharmaceutical products (pharmaceuticals, medicines, diagnostic agents and others), crop protection products (e.g. herbicides, insecticides, fungicides), pest control agents (e.g. pesticides) and/or seeds. However, it is also conceivable to apply the invention to non-physical objects such as data (music files, image files, video files, document files, presentation files, data packets, software modules, programming libraries, or the like).

An object within the meaning of the invention can comprise a plurality of components; an object may be a product in packaging, for example. It is also conceivable that an object is a pallet or a transport box or a container or the like, which comprises a multiplicity of objects (e.g. goods).

The starting point for the present invention is a plurality of objects. The term “plurality” means a number N of more than ten, preferably more than one hundred. Usually, the number N of the objects tracked according to the invention is more than a thousand. N is an integer as already described in the introduction.

It is conceivable that the plurality of objects comprises both physical and non-physical objects; for example, multiple objects can be combined into one logical object (see WO2018019720A1, page 5, line 27 to page 6, line 5).

An object within the meaning of the present invention is uniquely identifiable, i.e. it can be distinguished from other objects, by means of a unique identifier. The term “unique identifier” means that the unique identifier can be associated with precisely one object; there are thus no two objects that have the same identifier.

The unique identifier may be a number or an alphanumeric code or a binary code or a hexadecimal code or the like.

Under the unique identifier, the respective object is processed in an electronic data processing system (EDP system), i.e. a unique identifier represents the respective object in the EDP system. The unique identifier of an object is also referred to in this description as the object identifier.

Usually, physical objects are equipped with an information carrier which comprises the respective object identifier. For example, the object identifier may be printed on the object as an optoelectronic code (e.g. as a barcode or 2D code (e.g. DataMatrix or QR code)) or that the object identifier is stored in an RFID transponder connected to the object.

The objects of the present invention are processed, i.e. they are subject to at least one process step, usually a multiplicity of process steps. Such a process step is also referred to as an event in this description. Such an event usually results in a change in the state/status of the respective object. Examples of events are: packing, loading, transporting, dispatching, receiving, unloading, reloading, repackaging, unpacking, heating, cooling and the like. Events in the sense of the invention can also be state changes/status changes that are unwanted, such as being lost, being dropped, breaking apart and the like. Furthermore, it is conceivable that an object does not undergo a state change due to an event; for example, it is conceivable that multiple objects are combined into one logical object according to an event (collectivization). It is also possible to combine multiple events into one event, for example, an event called “Transport” can include the events “packing”, “loading”, “moving from a place A to a place B” and “unloading”.

For the definition of an event, it is necessary to specify at least the state change/status change (what happened) and identify the affected objects (which objects are affected).

Usually, there are definitions for “default events” that can occur for objects.

In addition, events can be defined by further information, e.g. when the event occurred, where the event occurred, by whom the event was initiated/performed, why the event occurred, and the like.

An event (like an object) usually has a unique identifier under which the event can be identified. Such an event identifier represents the respective event in an EDP system. The unique identifier may be a number or an alphanumeric code or a binary code or a hexadecimal code or the like.

Usually, an object undergoes multiple events. In this case, the multiple events usually follow one another chronologically. If two events occur at the same time, they can either be combined into one event, or a decision is taken in favor of one of the events that is assumed to have occurred before the other event. If an object undergoes more than one event, an event history (chain of events) can still be constructed. An event history is a chain of consecutive events. In such an event history, there is an event that occurred most recently for the respective object. This event is also referred to in this description as the “last event” or “most recent event”. In addition, such an event history contains a first event. With the exception of the first event, each event in the event history is immediately preceded by exactly one event (or, as described above, an event history can be constructed in which, with the exception of the first event, each event is immediately preceded by exactly one event). This immediately prior or preceding event is also referred to in this description as a previous event. In this case, the term “immediately” means that according to the event history, no further event has occurred (or been recorded) for the respective object between an event and its previous event.

Usually, the number n of events that can occur for the plurality of objects is less than the number of objects (n<N). Typically, specific events occur for multiple objects. Thus, an event E₁ usually affects more than one object, an event E2 affects more than one object, and so on.

As described above, the present invention is used to track a plurality of objects. The term “tracking” means that the event history for the individual objects is collected and recorded so that the event history can be determined (reproduced) on the basis of the information recorded for each object.

According to the present invention, the collection and recording of event histories of objects is carried out using two tables, a first table and a second table. The term “table” should be interpreted broadly. The term “table” refers to any ordered collection of data.

A first table contains information about the objects that are being tracked. In the first table, for each object for which at least one event has occurred, (only) the last event that occurred (the last/most recent event) is entered.

In the second table, for each event that has occurred for at least one object and which is preceded by at least one event, (only) the immediately preceding event (the previous event) is entered.

If a new event E occurs for a number N of objects, the last events for the objects already entered in the first table are replaced by the new (last) event E. In addition, the new event E is entered in the second table and for the new event E, the event immediately preceding the event E is entered. Thus, for each new event that occurs, only a single new entry is added, while in the previous (classical) procedure described in the introduction to this description, for each new event as many new entries are added as there are objects affected by the event. This means that the present invention requires less storage for the tracking of objects than the previous procedure for the tracking of objects. In addition, there is less data traffic for exchanging information about objects between different participants.

If there is a need to find out the event history for an object, it is necessary to first identify the last event for that object in the first table. Then the second table is checked to see whether the last event was preceded by an event. If not, the event history consists of only the last event. If a previous event is listed for the last event in the second table, the event history includes at least the last event and its previous event. Then, using the second table, it is checked whether the previous event itself has a previous event. If not, the event chain consists only of the last event and its previous event. If, on the other hand, the previous event of the last event itself has a previous event, then the event chain includes at least the last event, its previous event and the previous event of the previous event. The process of checking whether another previous event exists is continued until there is no further previous event. The event history then consists of the last event and all identified previous events.

The invention is elucidated in detail below with reference to figures, without any intention to restrict the invention to the features or combinations of features shown in the figures.

In the figures below: FIG. 1 schematically shows the tracking of objects according to the previous (classical) procedure. FIGS. 1(a) to 1(d) have already been described in detail above.

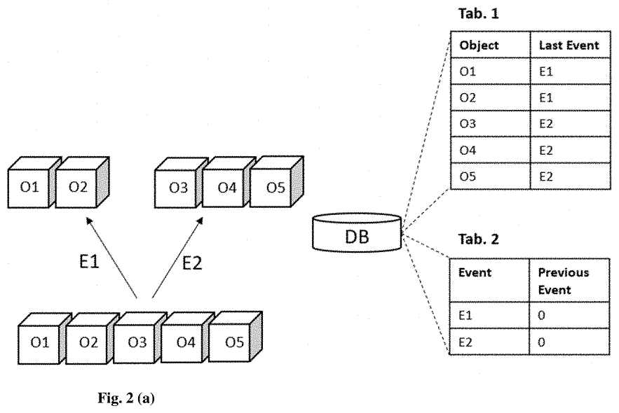

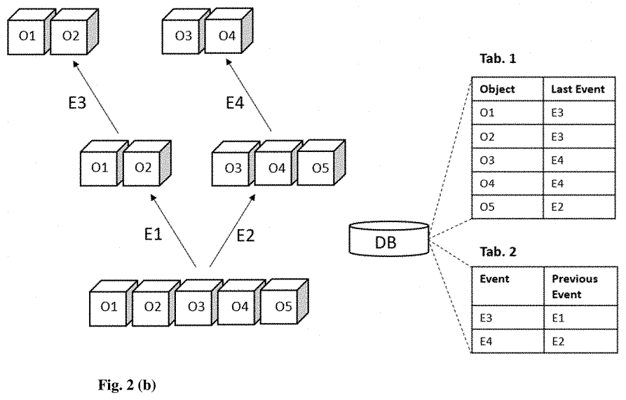

FIG. 2 shows, in schematic form and by way of example, a preferred embodiment of the present invention. The situation shown in FIG. 2(a) directly follows the situation shown in FIG. 1(a). The starting point of the invention are the five objects O1, O2, O3, O4 and O5 already depicted in FIG. 1(a), which can be identified by their unique identifiers. In a data store DB, information about the objects is collected in tabular form based on the unique object identifiers. In FIG. 2(a), two events E1 and E2 have occurred.

Event E1 affects the objects O1 and O2; event E2 affects the objects O3, O4 and O5. In the data memory DB, a first table (Tab. 1) records the fact that event E1 has occurred for objects O1 and O2 and that event E2 has occurred for objects O3, O4 and O5. In a second table (Tab. 2), for each event that has occurred the event which immediately preceded the respective event (Previous Event) is stored. In the present case, no events have preceded the events E1 and E2. Therefore, in the second table a zero is entered in the respective Previous Event field for the events E1 and E2. It is also conceivable that the second table only lists those events that have a previous event. Since the events E1 and E2 have no previous events, it is therefore conceivable that the second table shown in FIG. 2(a) has no entries, i.e. is empty. This procedure of including in the second table only those events that have a previous event is implemented for the scenarios shown in FIGS. 2(b) and (c).

In FIG. 2(b) (as in FIG. 1(c)), two new events have occurred, E3 and E4, with event E3 affecting objects O1 and O2 and event E4 affecting objects O3 and O4. In contrast to the procedure shown in FIG. 1(c), in the case of FIG. 2(b), in the first table (Tab. 1) only the most recently occurring event for the objects is recorded (E3 for O1 and O2; E4 for O3 and O4, and E2 for O5). In the second table (Tab. 2), for each event that has a previous event the corresponding previous event is recorded (E1 is the previous event of E3 and E2 is the previous event of E4; E1 and E2 have no previous events).

The combination of the first table and the second table can be used to read off the history of the events that occurred for each object. This is explained by the example of the object O1. The last event that occurred for object O1 according to the first table is event E3. According to the second table, event E3 is preceded by event E1. Event E1 is not listed in the second table (or, as described in relation to FIG. 2 (a), it is recorded in the second table for the event E1 that it has no previous event). Accordingly, the event history for object O1 is: E1→E3.

The procedure shown in FIG. 2(b) uses fewer entries in the data store for tracking objects than the procedure shown in FIG. 1(c); in the case of FIG. 2(b) there are 7 entries (distributed over two tables) and in the case of FIG. 1(c) there are 9 entries.

In FIG. 2(c) (as in FIG. 1(d)) four new events have occurred, E5, E6, E7 and E8, wherein event E5 affects the objects O1 and O2, event E6 affects object O3, event E7 affects object O4 and event E8 affects object O5. In the first table (Tab. 1), again only the event that occurred last is recorded for each object. This means that “new last event occurred” replaces the “last event occurred up to now”. In the second table (Tab. 2), for each event that has a previous event the respective previous event is recorded.

The combination of the first table and the second table can be used to read off the history of the events that occurred for each object. This is explained using the example of object O4. The last event that occurred for object O4 according to the first table is event E7. According to the second table, event E7 is preceded by event E4. Furthermore, according to the second table, event E4 is preceded by event E2. Event E2 is not listed in the second table (or, as described in relation to FIG. 2 (a), it is recorded in the second table for the event E2 that E2 has no previous event). Accordingly, the event history for object O4 is: E2→E4→E7.

The procedure shown in FIG. 2(c) uses fewer entries for tracking objects than the procedure shown in FIG. 1(d); in the case of FIG. 2(c) there are 11 entries (divided over two tables) and in the case of FIG. 1(d) there are 14 entries.

In this example, the difference in the number of entries is comparatively small (11 entries compared to 14 entries in relation to the scenarios of FIGS. 2(c) and 1(d)). This is because the events listed in this example only affected a small number of objects. Events E6, E7 and E8, for example, affected only a single object in each case. In the event that there are individual events for each object and that no two (or more) objects are subject to the same event, the numbers of the entries for the procedure shown in FIGS. 1 (classical) and 2 (according to the invention) are the same size. However, events usually affect a large number of objects. In this case, the tracking of objects according to the invention requires far fewer entries in a data store than in the classical procedure.

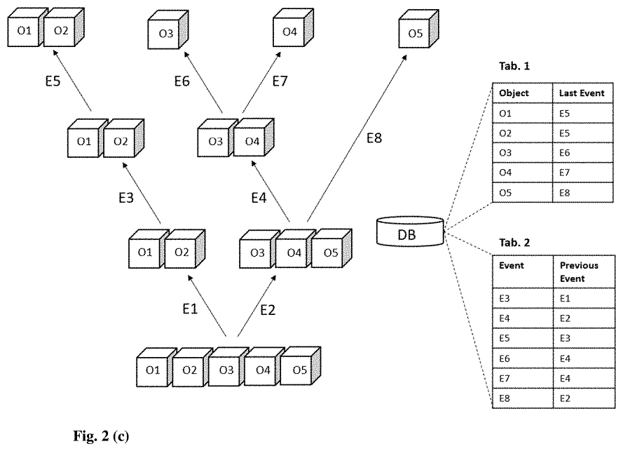

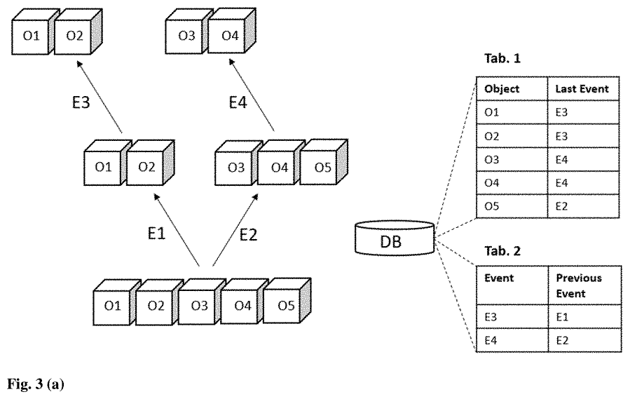

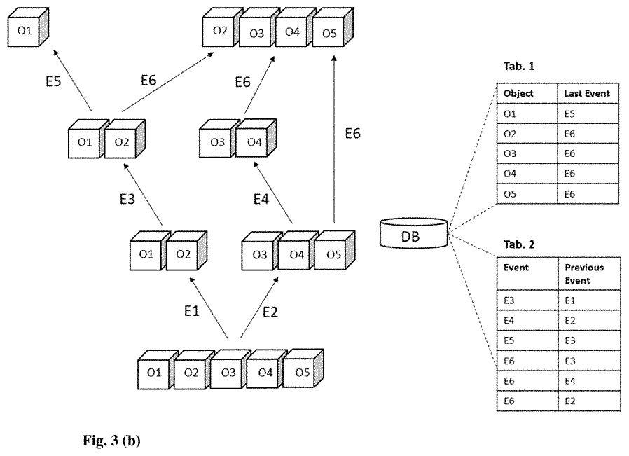

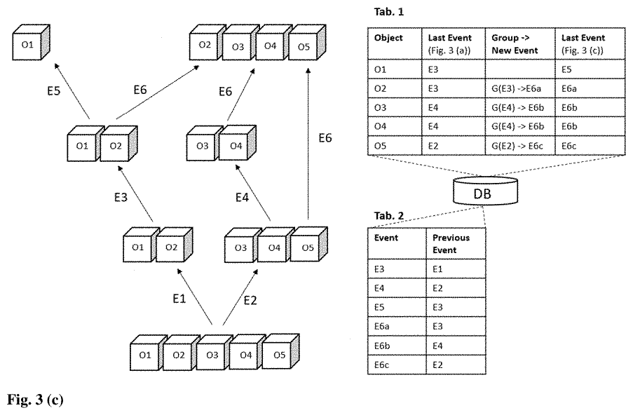

FIG. 3 shows exemplarily and schematically a further embodiment of the present invention. In FIG. 3(a), the event history is shown schematically for five objects O1, O2, O3, O4 and O5. The event histories are
for the objects O1 and O2: E1→E3
for the objects O3 and O4: E2→E4
for the object O5: E2.

In the first table (Tab. 1) therefore
for objects O1 and O2 it is recorded that the last event is event E3,
for objects O3 and O4 it is recorded that the last event is event E4, and
for object O5 it is recorded that the last event is event E2.

In the second table (Tab. 2) therefore
for event E3, it is recorded that its previous event is event E1, and
for event E4, it is recorded that its previous event is event E2.

The scenario shown in FIG. 3(a) corresponds to the scenario shown in FIG. 2(b).

The scenario shown in FIG. 3(b) directly follows the scenario shown in FIG. 3(a). A new event E6 has occurred. Event E6 affects the objects O2, O3, O4, and O5. If, as described earlier, for each object affected by event E6 the last event in the first table (Tab. 1) were to be replaced by event E6, and in the second table (Tab. 2) the previous event for the event E6 recorded, three previous events for the event E6 would result, depending on the object with which the process was started. It would also no longer be possible to reproduce the event history for each object from the combination of the first table and the second table. The reason for this discrepancy is that the same event occurred for the objects O2, O3, O4, and O5, but the objects have different event histories. This can happen, for example, when the events are defined very generically, such as the “acceptance by the customer” event. To eliminate this discrepancy, events can be defined more specifically to prevent an event from occurring in different locations of different event histories.

A preferred embodiment, on the other hand, creates different event identifiers for an event that occurs for objects that have different event histories. This is depicted schematically and exemplarily in FIG. 3(c). The information is received that an event E6 has occurred that affected the objects O2, O3, O4, and O5. In a first step, the first table (Tab. 1) is used to check whether all objects affected by the event E6 have the same last event. The last events have been copied from FIG. 3(a) into the first table of FIG. 3(c). The objects O3 and O4 have the same last event: E4. The objects O2 and O5, on the other hand, have different last events: E3 (in the case of O2) and E2 (in the case of O5). Because the objects affected by event E6 do not all have the same last event, the last events listed in the first table cannot simply be replaced by the new event E6. Instead, in a first step groups are formed. As many groups are formed as there are different last events for the affected objects. In this case, there are three different last events for the affected objects O2, O3, O4 and O5: E3, E4 and E2. Thus, three groups are formed. The most recent events are assigned to the groups; that is, there is a group to which the last event E3 is assigned, there is a group to which the last event E4 is assigned, and there is a group to which the last event E2 is assigned. The objects are assigned to the groups. Each object is assigned to exactly one group, specifically the group to which the event that is the last event for the respective object is assigned. The object O2 is assigned to the group to which the last event E3 is assigned. The objects O3 and O4 are assigned to the group to which the event E4 is assigned. The object O5 is assigned to the group to which the last event E2 is assigned. In the next step, the same number of event identifiers as there are groups are generated for the new event E6; in this case, three event identifiers, namely the event identifiers E6a, E6b, and E6c. Each event identifier is assigned to exactly one group; this can be carried out arbitrarily; in this case, the group with the object O2 is assigned the event identifier E6a, the group with the objects O3 and O4 is assigned the event identifier E6b, and the group with the object O5 is assigned the event identifier E6c. In the next step, in the first table, for each object, the last event from FIG. 3(a) is replaced by the event identifier assigned to the group to which the object belongs. In this case, the last event for object O2 is event E6a, the last event for objects O3 and O4 is event E6b, and the last event for object O5 is event E6c. For O1, according to FIG. 3(a), the previous last event is E3. For O1, according to FIG. 3(c), the new event E5 has occurred. The object O1 is the only object in FIG. 3(c) for which the event E5 has occurred. Accordingly, in the first table for the object O1, the previous last event (E3) is replaced by the new last event (E5).

In the second table, a new entry is created for all last events newly occurring in the first table. For the last event E5, it is recorded that the previous event is event E3; for the last event E6a it is recorded that the previous event is event E3; for the last event E6b it is recorded that the previous event is event E4; for the last event E6c it is recorded that the previous event is event E2.

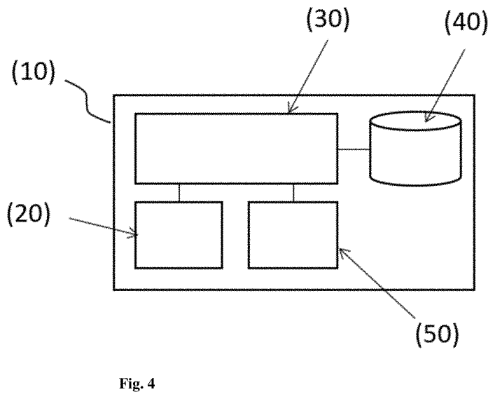

FIG. 4 shows, schematically and exemplarily, an embodiment of the device according to the invention. The device (10) comprises an input unit (20), a control and calculation unit (30), a data store (40) and an output unit (50).

Via the input device (20), the device (10) receives information about events and the objects affected by the events.

The control and calculation unit (30) is configured to manage the information about the events and objects in order to allow an event history to be reproduced for each object. For this purpose, the control and calculation unit (30) creates and maintains two tables, a first table and a second table. The tables can be stored in the data store (40) and/or displayed to a person via the output unit (50). The data store (40) can be an integral component of the device (10), but it is also conceivable that the data store (40) can be designed as a separate unit, which the control and calculation unit (30) can access via a network, for example.

The device according to the invention may be implemented in the form of a computer system. A “computer system” is an electronic data processing system that processes data by way of programmable computing rules. Such a system usually comprises a “computer”, the unit that comprises a processor for performing logic operations, and also peripherals.

In computer technology, “peripherals” denotes all devices that are connected to the computer and are used to control the computer and/or as input and output devices. Examples thereof are monitor (screen), printer, scanner, mouse, keyboard, drives, camera, microphone, speakers, etc. Internal ports and expansion cards are also regarded as peripherals in computer technology.

Modern computer systems are frequently divided into desktop PCs, portable PCs, laptops, notebooks, netbooks and tablet PCs, and what are called handhelds (e.g. smartphones); all these devices can be utilized for execution of the invention.

Inputs into the computer are achieved via input means such as, for example, a keyboard, a mouse, a microphone, a network connection, an external data memory and/or the like. Input should also be understood to mean the selection of an entry from a virtual menu or from a virtual list or clicking on a checkbox and the like. Outputs are usually achieved via a screen (monitor), on a printer, via loudspeakers and/or by storage on a data memory.

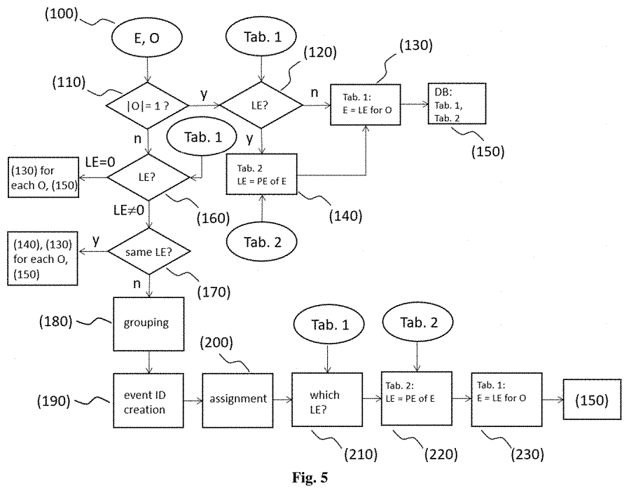

FIG. 5 shows schematically in a flowchart the steps that a computer system performs in a preferred embodiment of the present invention when the computer system according to the invention is loaded in a working memory of the computer system and executed.

In a first step (100), the computer system receives information about an event E and one or more objects O that are affected by the event. Typically, it receives the event identifier from the event that occurred, and a list of object identifiers of the objects affected by the event.

In a further step (110), a check is made as to whether the event affects only one object (|O−=1?). In the case that only one object is affected (step (110): “y”), in a further step (120) a first table (Tab. 1) is used to check whether an event has already occurred for the object (LE?). If the first table for the object contains an entry for a last event (LE), an event has already occurred. If no event has yet occurred for the object (step (120): “n”), in a further step (130) it is recorded in the first table for the object that the last event that affected the object is the event E (E=LE for O). If there is already an event for the object in the first table (step (120): “y”), it is recorded in a second table (Tab. 2) that this event (LE) is the previous event (PE) of the event E (LE=PE of E). In a further step (130), it is recorded in the first table for the object that the event E is now the last event (LE) of object O (E=LE for O). The previous last event is thus replaced by the new last event. The updated tables (Tab. 1 and/or Tab. 2) are saved in a data store (DB: Tab. 1, Tab.2) in a further step (150).

In the event that there are more than one objects affected by event E (step (110): “n”), in a further step (160) it is checked using the first table (Tab. 1) which objects affected by event E already have an event (LE≠0) and which objects affected by event E have no event (LE=0). For all those objects that so far have no event (LE=0), the step (130) is performed, i.e. it is recorded in the first table (Tab. 1) that event E is the last event for the respective object, and the first table is then stored in the data store (step (150)). For all objects that already have an event (LE≠0), a further step (170) checks whether they all have the same last event (same LE?). In the event that all objects have the same last event (“y”), the steps (140) and (150) are performed for each individual object, that is, in the second table (Tab. 2) it is recorded that the last event is the previous event of event E, and in the first table (Tab. 1) it is recorded that event E is the last event for the respective object. Then the updated tables (Tab.1 and Tab. 2) are stored in the data store (step (150)). In the event that one or more objects have different last events (step (170): “n”), in a further step (180) groups are formed and the objects are assigned to the groups based on the last events (“grouping”). If two objects have the same last event, they are assigned to the same group. There are as many groups as there are different last events. In a further step (190), new event identifiers are created for event E (“event identifier creation”). As many event identifiers are generated as there are groups. In a further step (200), the created event identifiers are assigned to the groups (“assignment”); this can be carried out arbitrarily; each group is assigned one event identifier. Due to the group membership, an event identifier is also assigned to each object. In a further step (210), using the first table (Tab. 1) for the individual objects, it is checked which last event is recorded for them in the first table (“which LE?”). The respective last event is the previous event for the created event identifier assigned to the object. In a further step (220), the corresponding previous event is recorded in the second table for each event identifier created. In a further step (230), for each object in the first table, the previous last event is replaced by the created event identifier assigned to the object. In a further step (150), the updated tables (Tab.1 and Tab. 2) are stored in the data store.

What is claimed is:

1. A method for tracking objects, comprising the steps of:
providing a plurality of objects;
recording events that have occurred for the objects; and
storing information about the objects and the events that occurred in a first table and in a second tablet;
wherein in the first table, each object is represented by a unique object identifier;
wherein in the first table, for each object the most recent event that occurred for that particular object is stored;
wherein in the second table, for each event which is immediately preceded by an event, the previous event is entered.

2. The method as claimed in claim 1, further comprising the steps of:
receiving object identifiers of a plurality of objects;
generating a first table, wherein each object in the first table is represented by the respective object identifier;
receiving information about events and about the objects for which the respective events occurred;
for all objects for which at least one event has occurred: entering the last event that occurred in the first table;
creating a second table;
for each event that occurred for at least one object and is preceded by at least one event: entering the immediately preceding event in the second table;
storing the first table and the second table in a data store.

3. The method as claimed in claim 1, further comprising the steps of:
receiving information about an event E and about the objects for which the event E has occurred;
for all objects for which the event E has occurred: replacing the respective last event LE by the event E in the first table; and
creating a new entry in the second table, wherein for the event E it is recorded that the previous event of event E is the event LE.

4. The method as claimed in claim 1, further comprising the steps of:
receiving information about an event E and about the objects for which the event E has occurred;
checking, using the first table, whether the same last event LE has occurred for all objects for which the event E has occurred;
in the event that the same last event LE occurred for all objects for which event E has occurred:
for all objects for which the event E has occurred: replacing the respective last event LE by the event E in the first table; and
creating a new entry in the second table, wherein for the event E it is recorded that the previous event of event E is the event LE;
in the event that the same last event LE did not occur for all objects for which the event E has occurred:
forming groups for all objects for which the event E has occurred, each group comprising those objects that have the same last event;
creating as many new event identifiers for the event E as groups were formed;
for each group: assigning a new event identifier to a group;
for all objects for which the event E has occurred: replacing the respective last event in the first table by the new event identifier that was assigned to the group to which the object belongs;
for each new event identifier: creating a new entry in the second table, wherein the previous event that is recorded for the new event identifier is the last event which it replaced in the first table.

5. The method as claimed in claim 1, wherein at least some of the objects are physical objects, preferably goods.

6. The method as claimed in claim 5, wherein objects that are physical objects each bear a unique object identifier.

7. The method as claimed in claim 1, further comprising the step of: displaying the first and/or second table to a person, preferably on a display screen.

8. The method as claimed in claim 1, further comprising the steps of:
reproducing an event history for an object, comprising the partial steps of:
(a) determining the last event for the object using the first table;
(b) using the second table, determining whether there is a previous event for the last event;
(c) if there is no previous event: creating the event history, wherein the event history comprises only the last event
(d) if there is a previous event:
(i) using the second table, checking whether the previous event itself has a previous event;
(ii) repeating the partial step (i) until no further previous event is found for a previous event;
(iii) creating the event history, wherein the event history comprises the last event and the previous events in the order in which they were found;
outputting the event history to a person.

9. A device comprising:
an input unit;
a control and calculation unit; and
a data memory;
wherein the control and calculation unit is configured to prompt the input unit to receive object identifiers of a plurality of objects;
wherein the control and calculation unit is configured to create a first table, wherein each object in the first table is represented by the respective object identifier;
wherein the control and calculation unit is configured to prompt the input device to receive information about events and about the objects for which the respective events occurred;
wherein the control and calculation unit is configured to record in the first table which event occurred last for the objects;
wherein the control and calculation unit is configured to create a second table and, for each event preceded by an event, to record the immediately preceding event in the second table;
wherein the control and calculation unit is configured to store the first table and the second table in the data store.

10. A non-transitory computer program product comprising program code that is stored on a data carrier and that causes a computer system to execute the following steps when the program code is loaded into the working memory of the computer system:
receiving object identifiers of a plurality of objects;
generating a first table, wherein each object in the first table is represented by the respective object identifier;
receiving information about events and about the objects for which the respective events occurred;
for all objects for which at least one event has occurred: entering the last event in the first tablet;
creating a second table;
for each event that occurred for at least one object and is preceded by at least one event: entering the immediately preceding event in the second table;
storing the first table and the second table in a data store.

11. The computer program product as claimed in claim 10, wherein the program code causes the computer system to further execute the following steps:
providing a plurality of objects;
recording events that have occurred for the objects; and
storing information about the objects and the events that occurred in a first table and in a second table;
wherein in the first table, each object is represented by a unique object identifier;
wherein in the first table, for each object the most recent event that occurred for that particular object is stored;
wherein in the second table, for each event which is immediately preceded by an event, the previous event is entered.
